(19) United States
(12) Patent Application Publication
(10) Pub. No.: US 2022/0324000 A1
(43) Pub. Date: Oct. 13, 2022

(54) CLEANING A COOKING SYSTEM

(71) Applicant: Evo America, LLC, Tualatin, OR (US)

(72) Inventor: Robert A. Shingler, Beaverton, OR (US)

(21) Appl. No.: 17/658,168

(22) Filed: Apr. 6, 2022

Related U.S. Application Data
(60) Provisional application No. 63/171,968, filed on Apr. 7, 2021.

(51) Int. Cl. B08B 9/027; B08B 3/02

(52) U.S. Cl. CPC B08B 9/027; B08B 3/02; B08B 2209/027; B08B 2203/02

(57) ABSTRACT

Examples are disclosed that relate to ventilation systems for a cooking appliance and methods for cleaning a ventilation system for a cooking appliance. In one example, a method for cleaning a ventilation system for a cooking appliance comprises controlling, via an electronic controller, an introduction of a solution configured to disintegrate deposits within the ventilation system into a liquid delivery system of the ventilation system. The solution is distributed via one or more conduits of the liquid delivery system to one or more liquid delivery outlets of the ventilation system. The solution is applied to one or more surfaces within the ventilation system using the one or more liquid delivery outlets of the ventilation system.

### CROSS REFERENCE TO RELATED APPLICATION

The present application is based upon and claims priority under 35 U.S.C. 119(e) to U.S. Provisional Patent Application No. 63/171,968, filed Apr. 7, 2021, entitled CLEANING A COOKING SYSTEM, the entirety of which is hereby incorporated herein by reference for all purposes.

### BACKGROUND

Cooking may generate various byproducts, including fats, oils and grease (FOG). These byproducts may collect and form deposits in a ventilation system for a cooking appliance. As such, a ventilation system may require cleaning on a regular basis to remove such deposits. However, cleaning the ventilation system may be expensive, time consuming, and messy.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to ventilation systems for a cooking appliance and methods for cleaning a ventilation system for a cooking appliance. In one example, a method for cleaning a ventilation system for a cooking appliance comprises controlling, via an electronic controller, an introduction of a solution configured to disintegrate deposits within the ventilation system into a liquid delivery system of the ventilation system. The solution is distributed via one or more conduits of the liquid delivery system to one or more liquid delivery outlets of the ventilation system. The solution is applied to one or more surfaces within the ventilation system using the one or more liquid delivery outlets of the ventilation system.

Another example provides a ventilation system for a cooking appliance. The ventilation system comprises one or more surfaces and one or more liquid delivery outlets configured to apply a solution to the one or more surfaces. The solution is configured to disintegrate deposits within the ventilation system. The ventilation system further comprises a liquid delivery system comprising one or more conduits configured to distribute the solution to the one or more liquid delivery outlets of the ventilation system. A controller is configured to dispense the solution by providing the solution into the liquid delivery system on a programmatic basis.

Another example provides a ventilation system comprising a fan. The ventilation system further comprises one or more surfaces and one or more liquid delivery outlets configured to apply a solution to the one or more surfaces. The solution is configured to disintegrate deposits within the ventilation system. The ventilation system further comprises a liquid delivery system for dispensing the solution. The liquid delivery system comprises one or more conduits configured to distribute the solution to the one or more liquid delivery outlets of the ventilation system. The ventilation system further comprises a controller configured to determine that the fan is running. The controller is configured to dispense the solution on condition of determining that the fan is running.

### BRIEF DESCRIPTION OF THE DRAWINGS

FIG. 1 shows an example of a ventilation system for a cooking system.

FIG. 2 shows a schematic view of the ventilation system of FIG. 1.

FIG. 3 shows a schematic view of another example of a ventilation system for a cooking system.

FIG. 4 shows another example of a ventilation system for a cooking system.

FIG. 5 shows a schematic view of the ventilation system of FIG. 4.

FIG. 6 shows a flow diagram depicting an example method for cleaning a ventilation system for a cooking appliance.

FIGS. 7A and 7B show a flow diagram depicting another example method for cleaning a ventilation system for a cooking appliance.

FIG. 8 shows a block diagram of an example computing system.

FIG. 9 shows an example of a liquid proportioning level control.

### DETAILED DESCRIPTION

Cooking may generate various byproducts, including fats, oils and grease (FOG). These byproducts may collect and form deposits in a ventilation system for a cooking appliance, such as inside of a ventilation hood, a duct, a fan, and/or a roof section where the ventilation system is located. As such, the ventilation system may require cleaning on a regular basis (e.g., monthly, quarterly, or biannually) to remove such deposits. However, cleaning the ventilation system may be expensive, time consuming, and messy.

In some examples, the ventilation system may include a washdown system configured to spray detergents and surfactants at high pressure and optionally high temperature to physically remove deposits from the ventilation system and funnel effluent into a sewer drain. However, the washdown system may not be able to remove some deposits, such as those in hard-to-reach areas. In addition, funneling the removed FOG into a grease trap may require more frequent cleaning of the grease trap. In other examples, a pressurized sprayer may be used to manually apply a cleaning solution to the ventilation system to disintegrate FOG deposits. However, it can be difficult for a manual operator to properly apply the cleaning solution on a consistent basis, and the effectiveness of the manual operation is dependent upon operator skill and effort.

Accordingly, examples are disclosed that relate to ventilation systems for cooking appliances and methods for cleaning ventilation systems for cooking appliances. Briefly, a ventilation system comprises a cleaning solution distribution and dispensing system. An electronic controller of the distribution and dispensing system is used to control an introduction of a solution into the ventilation system, wherein the solution is configured to disintegrate deposits within the ventilation system. The solution is applied to one or more surfaces within the ventilation system using one or more liquid delivery outlets of the cleaning solution distribution and dispensing system. In this manner, the deposits may be conveniently eliminated on a regular schedule, which can lengthen an interval between regular maintenance and inspections of the ventilation system.

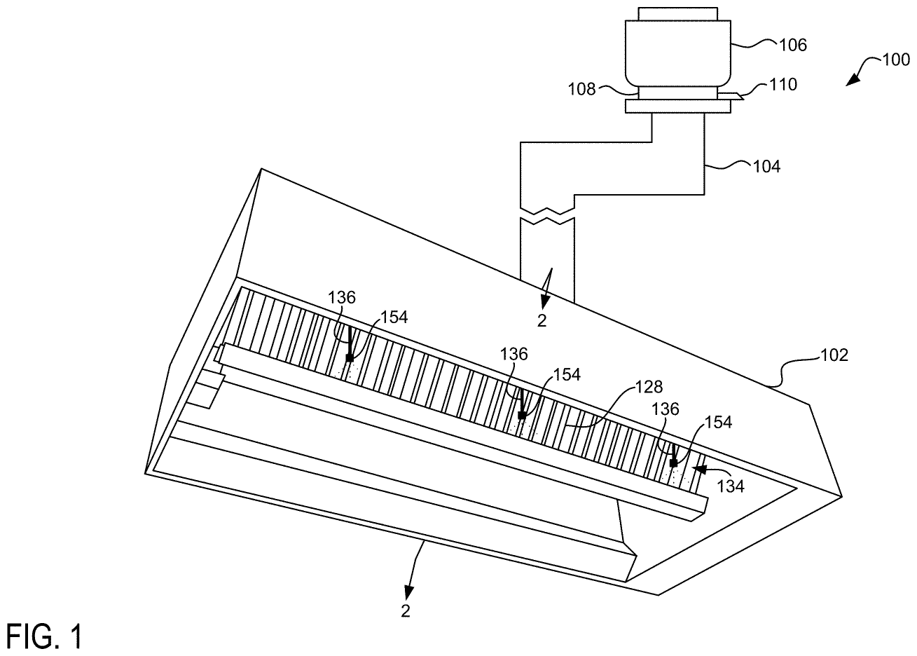

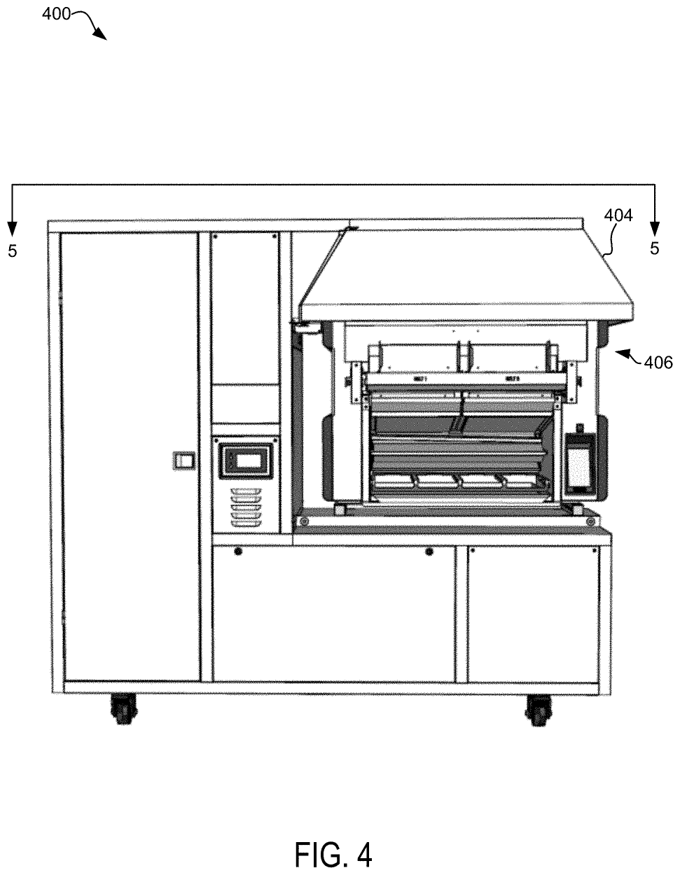

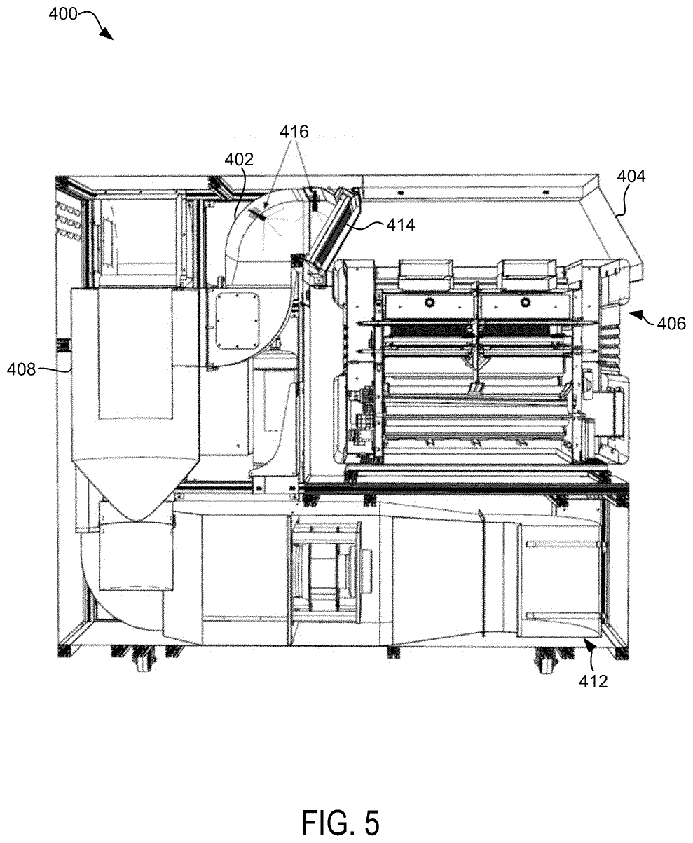

FIG. 1 shows an example ventilation system 100 according to the present disclosure. The ventilation system 100 includes a ventilation hood 102 and a ventilation duct 104 configured to attach to the ventilation hood 102 and vent exhaust from a cooking appliance (not shown). In the example of FIG. 1, the ventilation hood 102 is a type 1 hood configured to capture effluent from a hot cooking appliance and evacuate the effluent outside of an occupied cooking environment. It will also be appreciated that the ventilation system may take any other suitable form. For example, and as described in more detail below with reference to FIGS. 4 and 5, a recirculating ventilation system may permit cooking exhaust to be vented back into the occupied cooking environment.

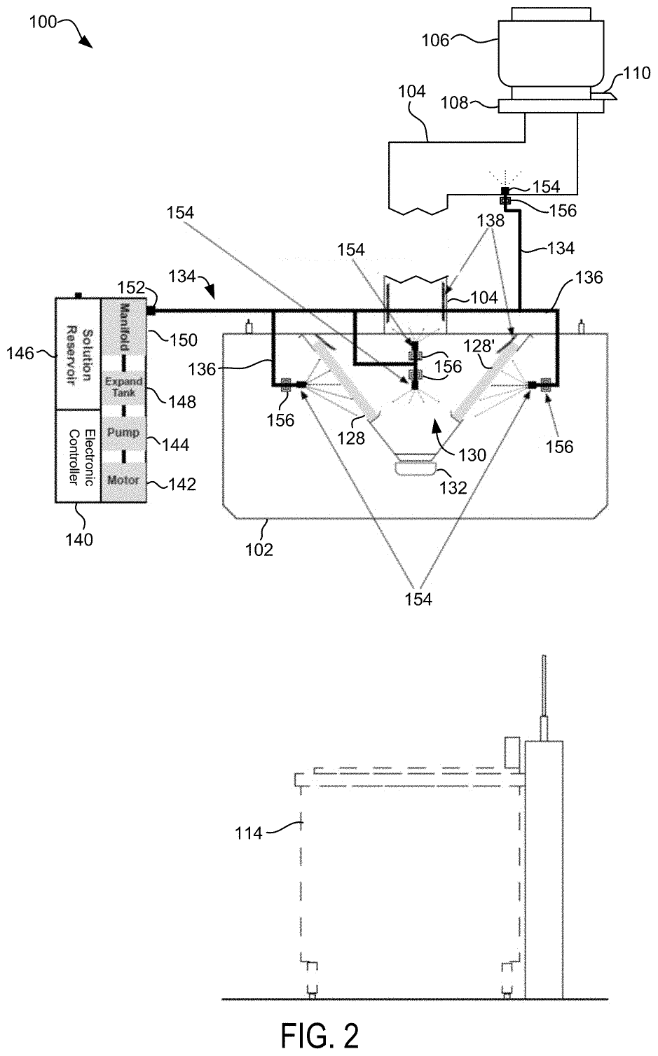

FIG. 2 shows a schematic cross-section view of the ventilation system 100 along line 2-2 of FIG. 1, positioned over an example of a cooking appliance. Any suitable cooking appliance may be used. In FIG. 2, the cooking appliance comprises a cooking grill 114. Other examples of cooking appliances include ovens, fryers, broilers, ranges, and griddles.

In the example of FIGS. 1 and 2, the ventilation hood 102 functions as an inlet aperture for the system 100. The ventilation hood 102 is integrally attached to the ventilation duct 104 (e.g., by coupling the cooking appliance to the ventilation duct 104 via a draw-latch or other securing mechanism) to help ensure that the inlet aperture and ventilation duct are properly connected to capture cooking exhaust.

Downstream of the inlet aperture and ventilation duct 104, the ventilation system 100 comprises a fan 106 configured to pull exhaust through the ventilation duct 104 and discharge the exhaust. In some examples, the fan 106 may be located outside of a building, while the ventilation hood 102 and the cooking appliance may be located inside of the building (e.g., in a commercial kitchen). In other examples, the fan may be configured to exhaust to an interior of a building, as described in more detail below. While shown as ventilating cooking exhaust from one cooking appliance in FIGS. 1 and 2, the system 100 may be configured to ventilate cooking exhaust from multiple appliances in other examples. In some examples, the fan 106 is configured to precipitate oil via centrifugal force. The precipitated oil gathers in a catch basin 108 and may be collected via an outlet 110. In some examples, the fan 106 is in line with the duct 104. In other examples, the fan 106 is not in line with the duct 104.

In the example in FIGS. 1 and 2, the ventilation hood 102 comprises a V-bank hood having two banks of grease baffle filters 128 and 128′. In some examples, the grease baffle filters 128 and 128′ are located on either side of a plenum space 130. In other examples, the ventilation hood 102 may have any other suitable configuration. For example, the ventilation hood may comprise one bank of grease baffle filters. The grease baffle filters 128 and 128′ are configured to remove FOG, which collects in a grease cup 132, before cooking exhaust is drawn through the plenum 130, the duct 104 and the fan 106.

In addition, the ventilation system 100 comprises a liquid delivery system 134. The liquid delivery system comprises one or more conduits configured to distribute a solution within the ventilation system 100. As introduced above, the solution is configured to disintegrate deposits within the ventilation system, such as deposits of FOG. In some examples, the solution comprises a nanotechnology configured to break down the FOG (e.g., disintegrating the FOG into water, carbon, and carbon dioxide) and thereby cause the broken-down components of the FOG to dissipate into the air traveling through the ventilation system. The solution may be a water-based cleaning solution with a viscosity similar to that of water. One example of a suitable cleaning solution is HOOD & FILTER provided by PILOT & NAVIGATOR, INC. of HONOLULU, HAWAII. In other examples, the solution comprises an enzyme configured to break down FOG deposits. In yet other examples, the solution comprises a non-enzymatic biologic solution. In some examples, the solution additionally or alternatively includes aqueous ozone and/or ozone gas. It will also be appreciated that the solution may have any other suitable composition and any other suitable properties.

In some examples, the one or more conduits configured to distribute the solution comprise one or more pipes 136 that are separate from the ventilation hood 102. In other examples, the one or more conduits comprise one or more conduits 138 constructed into and integral with the ventilation hood 102. Each of the one or more conduits 138 may comprise, for example, a channel formed from sheet metal that is welded to a surface of the ventilation system 100, such as a surface of the hood 102 or a wall of the duct 104. In yet other examples, as shown in FIG. 2, the liquid delivery system 134 may comprise a combination of the one or more pipes 136 and the one or more conduits 138. The liquid delivery system 134 may be separate from other liquid delivery systems within the ventilation system 100 (e.g., fire suppression systems and/or washdown systems).

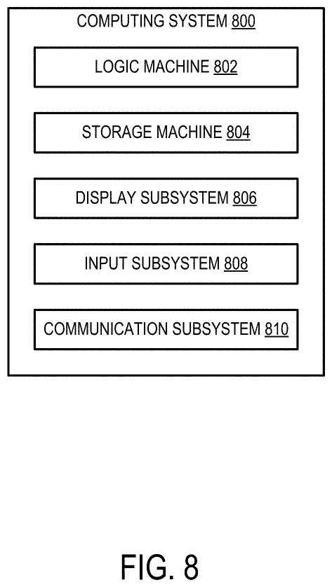

As described in more detail below, the solution is configured to be drawn through the ventilation system 100 and deposited on one or more surfaces within the ventilation system 100. As such, the liquid delivery system 134 may be operated even when the ventilation system 100 is not coupled to a drain. The ventilation system 100 further comprises an electronic controller 140 configured to control an introduction of the solution into the liquid delivery system 134. In some examples, the electronic controller 140 comprises a pulse width modulation (PWM) controller. In other examples the electronic controller 140 may take any other suitable form. The electronic controller 140 includes one or more aspects of a computing system. An example computing system is described in more detail below with reference to FIG. 8.

The electronic controller 140 may be configured to dispense the solution by providing an amount of the solution into the liquid delivery system 134 on a programmatic basis. In some examples, providing the solution on the programmatic basis comprises providing the solution on a predetermined schedule. The predetermined schedule may be a fixed schedule (e.g., twice per day), or a variable schedule. In other examples, providing the solution on the programmatic basis comprises dispensing a metered amount of the solution. The metered amount may be a fixed amount (e.g., 500 mL) each time the solution is dispensed, or the metered amount may be variable, for example, based upon a usage of a cooking appliance being ventilated.

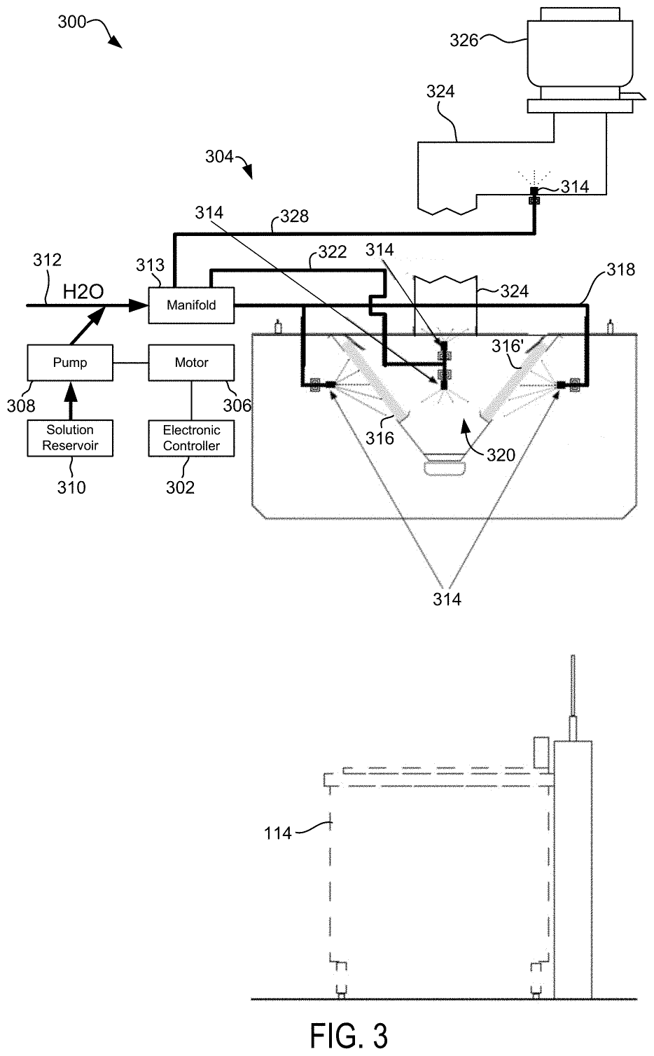

FIG. 3 shows a schematic view of another example of a ventilation system 300, in which the cleaning solution is drawn from a concentrate. Like the ventilation system 100 of FIGS. 1 and 2, the ventilation system 300 is provided over the cooking grill 114. The ventilation system 300 comprises an electronic controller 302 configured to control an introduction of the solution into a liquid delivery system 304. The electronic controller 302 is electrically coupled to a motor 306 that drives a pump 308, such as a peristaltic pump or a metering pump. The pump 308 is configured to meter the concentrate from a solution reservoir 310 and inject the concentrate into a tap water line 312 to dilute the solution. In some examples, the concentrate is diluted in a ratio of 1:2 or 1:3. It will also be appreciated that any other suitable dilution ratio may be used.

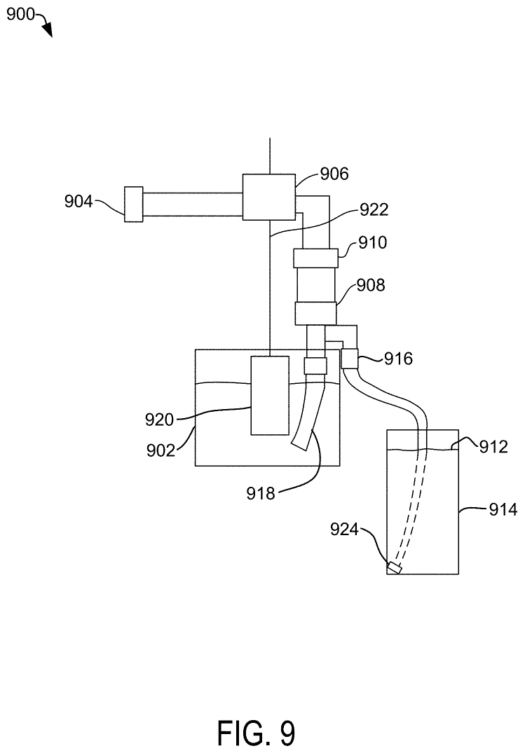

In other examples, a liquid proportioning level control allows the concentrate to be drawn into a reservoir using as-provided utility tap water pressure. Once the reservoir is full of the dilute solution, a pump will draw from the reservoir and dispense the solution into the liquid delivery system. Additional details regarding the liquid proportioning level control are provided in more detail below with reference to FIG. 9.

The diluted solution is provided into a manifold 313 which feeds pipe circuits connected to one or more liquid delivery outlets 314. As described in more detail below, the one or more liquid delivery outlets 314 may include one or more nozzles or any other suitable type of outlet configured to deliver the solution into the ventilation system 300. In some examples, two or more liquid delivery outlets 314 are provided that are connected to different pipe circuits. For example, the liquid delivery outlets 314 that service grease baffle filters 316 and 316′ are connected in a first pipe circuit 318. The liquid delivery outlets 314 located inside plenum space 320 are connected in a second pipe circuit 322 that is separate from the first pipe circuit 318. One or more liquid delivery outlets 314 that service ductwork 324 and/or an external fan 326 are connected in a third pipe circuit 328 that is separate from both the first pipe circuit 318 and the second pipe circuit 322. In this manner, the liquid delivery outlets 314 servicing different parts of the ventilation system 300 may be independently controlled.

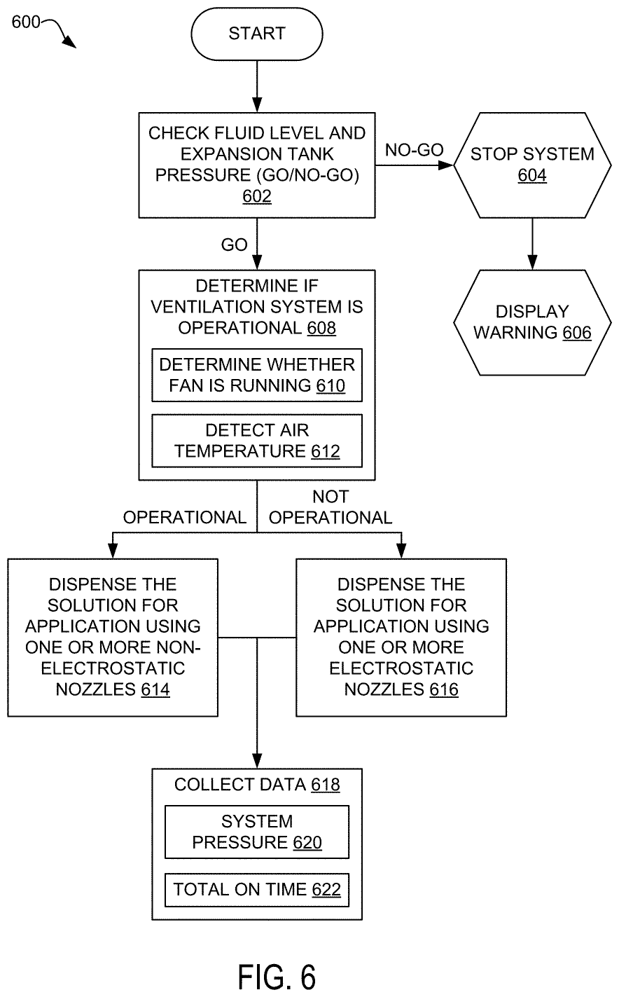

Further, and with reference again to FIGS. 1 and 2, providing the solution on the programmatic basis may comprise detecting operation of the ventilation system, such as by determining that the fan 106 is running. The controller 140 may be configured to regulate the introduction of the solution differently based on whether the ventilation system is running or not. Additional detail is provided below with reference to FIG. 6.

In some examples, the controller 140 is configured to control the introduction of the solution by releasing a controlled amount of the solution under pressure into the liquid delivery system 134. The ventilation system 100 includes a motor 142 and a pump 144 configured to draw the solution from a solution reservoir 146, and to pressurize the solution. The ventilation system 100 may also include an expand tank 148 or pressure head configured to provide the solution from the pump 144 to a manifold 150 at an even pressure, and to prevent introduction of air bubbles into the liquid delivery system 134.

The pressurized solution is released from the manifold 150 into the liquid delivery system 134 via a delivery valve 152, such as a solenoid valve, operated by the controller 140. Pulse width modulation may be used to adjust a rate at which the solution is transferred from the manifold into the liquid delivery system 134. The solution is distributed via the one or more conduits of the liquid delivery system 134 to one or more liquid delivery outlets 154 within the ventilation system 100. In some examples, the one or more liquid delivery outlets 154 comprise spray nozzles. As described in more detail below, the one or more liquid delivery outlets 154 may comprise electrostatic spray nozzles, non-electrostatic spray nozzles, or a combination of electrostatic and non-electrostatic spray nozzles. In other examples, the one or more liquid delivery outlets may include any other suitable type of outlets, such as drip nozzles. In some examples, two or more different liquid delivery outlets may be serviced via different liquid delivery systems or by regulating one or more control valves located within the liquid delivery system.

The one or more liquid delivery outlets 154 are configured to apply the solution to one or more surfaces within the ventilation system. As illustrated by example in FIG. 2, one or more of the liquid delivery outlets 154 may be configured to discharge the solution onto an outside surface of the grease baffle filters 128. Another one or more of the liquid delivery outlets 154 may be located on an opposite side of the V-bank and be configured to discharge the solution onto the grease baffle filters 128′. One or more further liquid delivery outlets 154 may be configured to discharge the solution inside of the plenum 130 and upwards into the duct 104. It will be appreciated that the depicted positions of the liquid delivery outlets 154 are illustrative and not limiting.

In some examples, the liquid delivery system 134 is configured to distribute the solution along at least a portion of the duct 104 that extends to the fan 106. In some examples, the one or more pipes 136 and/or the one or more conduits 138 (and/or any other conduit) may be located outside of the duct 104 or integrated into the wall of the duct 104. Further, one or more of the liquid delivery outlets 154 may be located at or within a wall of the duct 104. In this manner, the one or more pipes 136 and/or the one or more conduits 138 may not block airflow through the duct 104. In other examples, the liquid delivery system conduits may be located inside of duct 104.

As illustrated by example in FIG. 2, the ventilation system 100 may comprise one or more check valves 156 located downstream of the delivery valve 152 and upstream of the one or more liquid delivery outlets 154. In the example of FIG. 2, the ventilation system 100 comprises one check valve 156 located adjacent to each of the liquid delivery outlets 154.

Each of the one or more check valves 156 may be configured to open when a pressure of the solution upstream of the check valve is greater than or equal to a threshold pressure. In this manner, the one or more check valves 156 may ensure that the solution is provided to the one or more liquid delivery outlets 154 at or above the threshold pressure. When the one or more liquid delivery outlets 154 include a spray nozzle, each check valve 156 may ensure that the solution emerges from the nozzle under sufficient pressure to generate a mist or other desired spray characteristic (e.g., stream, cone, etc.).

The one or more check valves 156 may be configured to close when the pressure of the solution drops below the threshold pressure (for example, when the pump 144 or the delivery valve 152 is shut off. In this manner, the check valves 156 may allow the application of the solution to be cleanly shut off, ensuring that the one or more liquid delivery outlets 154 do not drip or leak when application of the solution is not desired.

FIGS. 4 and 5 show another example of a ventilation system 400 for a cooking appliance. The ventilation system 400 is a recirculating ventilation system that permits cooking exhaust produced during use of the cooking appliance to be vented back into an occupied cooking environment. FIG. 5 shows a cross-sectional view of the ventilation system 400 through line 5-5 of FIG. 4.

As illustrated by example in FIG. 5, the ventilation system 400 includes a ventilation duct 402 configured to ventilate exhaust from a cooking appliance. The ventilation duct 402 is configured to attach to a ventilation hood 404 disposed above a cooking component of the cooking appliance. As described above with reference to FIGS. 1 and 2, any suitable cooking appliance comprising any suitable cooking component may be used. In FIGS. 4 and 5, the cooking appliance comprises a broiler 406 and the cooking component comprises a cooking rack disposed beneath the broiler.

Like the ventilation system 100 of FIGS. 1 and 2, the ventilation system 400 comprises a fan 408 configured to pull fumes through the ventilation duct 402. However, in the example of FIGS. 4 and 5, the fan 408 may be configured to discharge filtered air into the cooking environment via a discharge air duct opening 412.

The ventilation system 400 also comprises a grease baffle filter 414 at an inlet aperture of the ventilation duct 402. One or more liquid delivery outlets 416 may be located inside of the ventilation duct 402. As described above, the one or more liquid delivery outlets 416 may be configured to inject a solution into the recirculating ventilation system 400 to help mitigate cleaning and grease accumulation.

In some examples, the one or more liquid delivery outlets 416 may be located proximate to the grease baffle filter 414 at the inlet aperture of the ventilation duct 402. By locating the one or more liquid delivery outlets 416 near the inlet aperture of the ventilation duct 402, the solution may be drawn through the ventilation system 400 to reach locations within the system where FOG could accumulate. In addition, dispensing the solution inside of the duct 402 may allow the solution to blend with airflow through the duct without evaporating. It will also be appreciated that the solution may be capable of disintegrating FOG even if its solution carrier is evaporated.

FIG. 6 shows a flow diagram depicting an example method 600 for cleaning a ventilation system for a cooking appliance. The following description of method 600 is provided with reference to the components described above and shown in FIGS. 1-5 and 7-8, but it will be appreciated that method also may be performed in other contexts using other suitable components.

At 602, the method 600 comprises checking a fluid level and an expansion tank pressure of the solution. For example, the ventilation system may include one or more liquid level sensors to monitor the fluid level of the solution in a solution reservoir (e.g., a five-gallon (or other suitable size) pail, or a clear one-gallon (or other suitable size) jug). The fluid level may be monitored using a suction tube that contains a level indicator. In other examples, the solution reservoir may be weighed to determine when the fluid level is low and the fluid needs replacement. In some examples, the fluid level may be output to an electronic controller or output to a user. By using a clear reservoir, the fluid level of the solution can also be directly observed by a human operator. The ventilation system may additionally or alternatively include one or more pressure sensors connected to the expansion tank to monitor the pressure of the solution.

As indicated at 602, the method 600 may include making a decision whether to proceed with cleaning based on the fluid level and expansion tank pressure. In some examples, a determination not to proceed may be made when the fluid level is below a threshold fluid level and/or when the expansion tank pressure is below a threshold expansion tank pressure, in which case, the method 600 proceeds to stop system operation at 604. In some examples, the method 600 may additionally or alternatively include, at 606, displaying a warning or an error message (e.g., “FLUID LOW”) based on the determination not to proceed.

On the other hand, when it is determined that fluid level and tank pressure exceed thresholds, then, at 602, the method 600 may proceed to determine if the ventilation system is operational 608. In some examples, determining if the ventilation system is operational comprises, at 610, determining whether a fan of the ventilation system is running. For example, the ventilation system may include one or more airflow sensor(s) and/or one or more static air pressure sensor(s) in one or more of the hood 102, the duct 104, or the plenum space 130. The airflow and/or static air pressure sensor(s) may be configured to detect a negative air pressure within the ventilation hood and thereby determine that the fan is running, and/or may detect an electrical state of the fan (e.g., detecting that the fan is energized) or of a signal related to fan state (e.g., a state of an indicator light or other indicator of fan operation).

Determining if the ventilation system is operational may additionally or alternatively include, at 612, detecting an air temperature within the ventilation system. For example, the ventilation system may include one or more temperature sensors configured to detect an increase in air temperature within the ventilation hood, which may indicate that cooking exhaust is being evacuated through the ventilation system.

On condition of determining that the ventilation system is operational, at 614, the method 600 comprises dispensing the solution for application. In some examples, one or more non-electrostatic nozzles may be used to dispense the solution when the ventilation system is operational.

In some examples, the solution may not be dispensed when the fan is not operational. In other examples, as indicated at 616, on condition of determining that the ventilation system is not operational, the method 600 comprises dispensing the cleaning solution for application using one or more electrostatic nozzles. The use of such nozzles may help to electrostatically attract the cleaning solution to surfaces in the ventilation system.

In some examples, the solution may be applied to different locations within the ventilation system based on whether the ventilation system is operational. In the example of FIG. 2, when the ventilation system is operational, the solution may be sprayed or dripped onto the grease baffle filters 128 and 128′, inside the plenum space 130, and inside the duct 104. The fan 106 may draw the solution through the ventilation system 100 to reach places where FOG could accumulate. When the ventilation system is not operational, the solution may be sprayed onto the inside of the hood 102, onto the outside of the grease baffle filters 128 and 128′, and inside the plenum space 130. In other examples, the solution may be applied to the same locations when the ventilation system is operational and when the ventilation system is not operational. In yet other examples, application of the solution is not tied to operation of other aspects (e.g., the fan) of the ventilation system, and may even be applied under manual control, rather than programmatic control.

In some examples, at 618, the method 600 includes collecting data. For example, the ventilation system may log system pressure at 620. The ventilation system may log a total system on time at 622. The data may be collected during steps 614 and 616, or at any other suitable step or combination of steps.

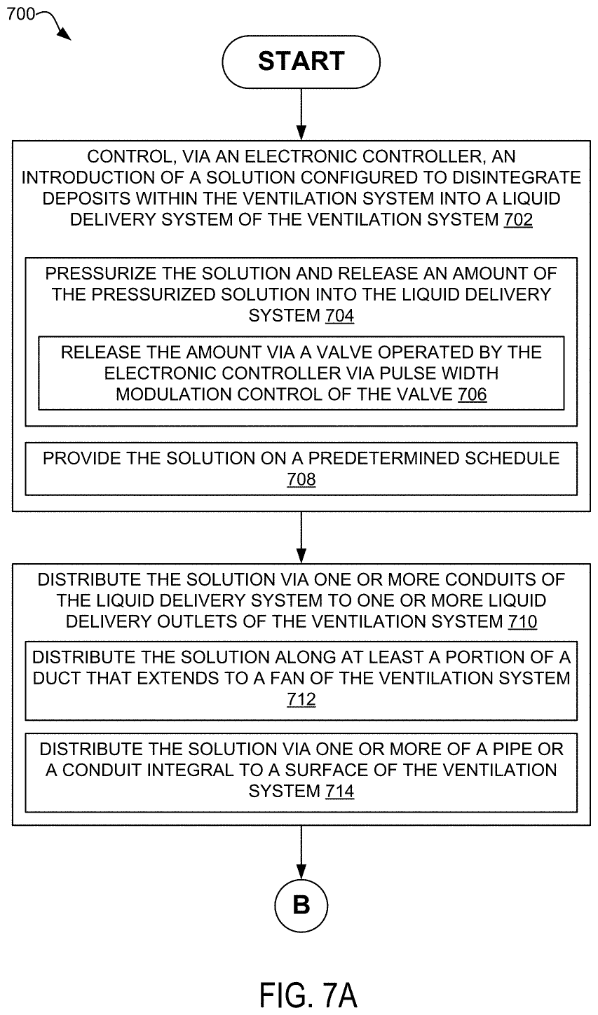

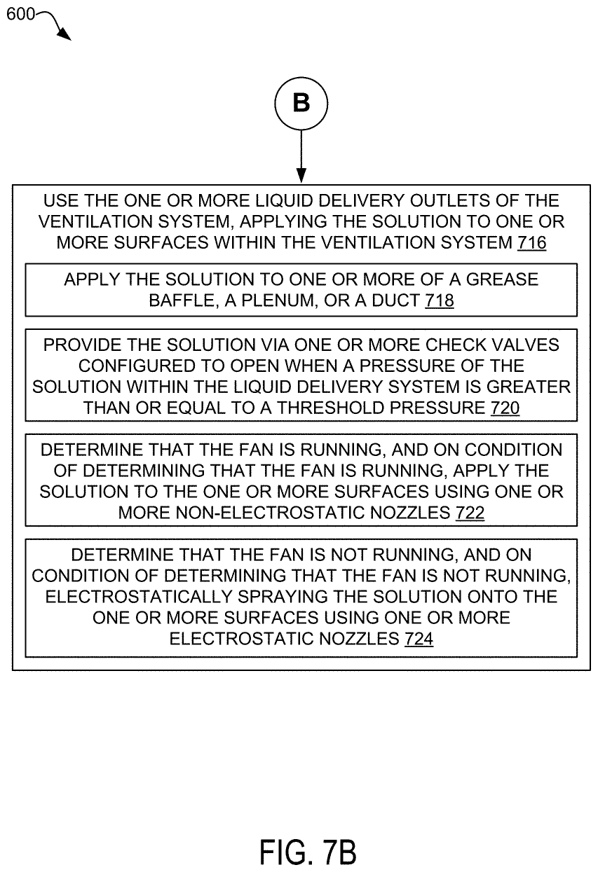

As mentioned above, the cleaning solution may disintegrate FOG residues while producing little to no liquid effluent. As such, the method 600 may be implemented in a drainless ventilation system. FIGS. 7A and 7B show a flow diagram depicting another example of a method 700 for cleaning a ventilation system for a cooking appliance. The following description of method 700 is provided with reference to the components described above and shown in FIGS. 1-6 and 8, but it will be appreciated that method also may be performed in other contexts using other suitable components.

With reference now to FIG. 7A, at 702, the method 700 includes controlling, via an electronic controller, an introduction of a solution configured to disintegrate deposits within the ventilation system into a liquid delivery system of the ventilation system. At 704, controlling the introduction of the solution may include pressurizing the solution and releasing an amount of the pressurized solution into the liquid delivery system. At 706, releasing the amount of the pressurized solution into the liquid delivery system may comprise releasing the amount via a valve operated by the electronic controller by pulse width modulation control of the valve. In some examples, as indicated at 708, the solution may be provided on a predetermined schedule. In other examples, the introduction of the solution may be manually controlled.

At 710, the method 700 includes distributing the solution via one or more conduits of the liquid delivery system to one or more liquid delivery outlets of the ventilation system. At 712, the method 700 may include distributing the solution along at least a portion of a duct that extends to a fan of the ventilation system. At 714, distributing the solution via the one or more conduits of the liquid delivery system may comprise distributing the solution via one or more of a pipe or a conduit integral to a surface of the ventilation system.

With reference now to FIG. 7B, at 716, the method 700 includes, using the one or more liquid delivery outlets of the ventilation system, applying the solution to one or more surfaces within the ventilation system. At 718, applying the solution to one or more surfaces within the ventilation system may comprise applying the solution to one or more of a grease baffle, a plenum, or a duct. At 720, applying the solution to the one or more surfaces may comprise providing the solution via one or more check valves configured to open when a pressure of the solution within the liquid delivery system is greater than or equal to a threshold pressure.

In some examples, as introduced above, the ventilation system comprises a fan. At 722, the method 700 may include determining that the fan is running, and on condition of determining that the fan is running, applying the solution to the one or more surfaces using one or more non-electrostatic nozzles. At 724, the method 700 may include determining that the fan is not running, and on condition of determining that the fan is not running, electrostatically spraying the solution onto the one or more surfaces using one or more electrostatic nozzles.

In some examples, the methods described herein may be tied to a computing system of one or more computing devices. In particular, such methods may be implemented as a computer-application program or service, an application-programming interface (API), a library, and/or other computer-program product.

FIG. 8 schematically shows a non-limiting embodiment of a computing system 800 that can enact one or more of the methods described above. Computing system 800 is shown in simplified form. Computing system 800 may take the form of one or more personal computers, server computers, tablet computers, mobile computing devices, mobile communication devices (e.g., smart phone), and/or other computing devices. The electronic controller 140 is an example implementation of the computing system 800.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result. For example, the logic machine 802 may be configured to implement method 600 and/or method 700 via executable instructions.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods described herein. When such methods are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 806 may be used to present a visual representation of data held by storage machine 804. This visual representation may take the form of a graphical user interface (GUI). As the herein described methods change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

FIG. 9 shows an example of a liquid proportioning level control 900. The liquid proportioning level control 900 is configured to fill and maintain a solution in a reservoir 902. In some examples, the reservoir 902 comprises the reservoir 146 of FIG. 2 or the reservoir 310 of FIG. 3. As described above, a pump (e.g., the pump 144 of FIG. 2 or the pump 308 of FIG. 3) can draw the solution from the reservoir 902 and dispense the solution into the liquid delivery system (e.g., the liquid delivery system 134 of FIG. 2 or the liquid delivery system 304 of FIG. 3).

The liquid proportioning level control 900 comprises an intake attachment 904 coupled to a valve assembly 906. The intake attachment 904 may be attached to a water supply, such as a hose configured to supply tap water to the liquid proportioning level control 900. When the valve assembly 906 is open, the tap water flows through a proportioner 908 via a backflow preventer 910. The proportioner 908 is configured to utilize back pressure generated by the flow of the tap water to draw a concentrated solution 912 from a container 914 (e.g., a one-gallon jug). In some examples, a foot valve 924 may be used to keep the liquid proportioning level control 900 primed after initial use.

The concentrate 912 is drawn through an optional metering tip 916 before being mixed with the tap water. In this manner, a suitable amount of the concentrate 912 may be mixed with the tap water to produce a solution having a suitable dilution ratio (e.g., 1:2 or 1:3). The diluted solution is provided into the reservoir 902 via an outlet 918.

In some examples, the reservoir 902 includes a float 920. The float 920 is coupled to the valve assembly 906 via a pull wire 922. In this manner, the float 920 is configured to close the valve assembly 906 when the reservoir 920 is full, thereby stopping the flow of water and concentrate from the outlet 918. The float 920 is also configured to open the valve assembly 906 when a fluid level of the diluted solution is low, thereby filling the reservoir.

Another aspect provides a method for cleaning a ventilation system for a cooking appliance, the method comprising: controlling, via an electronic controller, an introduction of a solution configured to disintegrate deposits within the ventilation system into a liquid delivery system of the ventilation system; distributing the solution via one or more conduits of the liquid delivery system to one or more liquid delivery outlets of the ventilation system; and using the one or more liquid delivery outlets of the ventilation system, applying the solution to one or more surfaces within the ventilation system.

The method may additionally or alternatively include, wherein applying the solution to one or more surfaces within the ventilation system comprises applying the solution to one or more of a grease baffle, a plenum, or a duct. The method may additionally or alternatively include distributing the solution along at least a portion of a duct that extends to a fan of the ventilation system. The method may additionally or alternatively include, wherein distributing the solution via the one or more conduits of the liquid delivery system comprises distributing the solution via one or more of a pipe or a conduit integral to a surface of the ventilation system.

The method may additionally or alternatively include, wherein controlling the introduction of the solution comprises pressurizing the solution and releasing an amount of the pressurized solution into the liquid delivery system. The method may additionally or alternatively include, wherein releasing the amount of the pressurized solution into the liquid delivery system comprises releasing the amount via a valve operated by the electronic controller via pulse width modulation control of the valve. The method may additionally or alternatively include, wherein applying the solution to the one or more surfaces comprises providing the solution via one or more check valves configured to open when a pressure of the solution within the liquid delivery system is greater than or equal to a threshold pressure.

The method may additionally or alternatively include, wherein controlling the introduction of the solution comprises providing the solution on a predetermined schedule. The method may additionally or alternatively include, wherein the ventilation system comprises a fan, and wherein the method further comprises: determining that the fan is running; and on condition of determining that the fan is running, applying the solution to the one or more surfaces using one or more non-electrostatic nozzles. The method may additionally or alternatively include, wherein the ventilation system comprises a fan, the method further comprising: determining that the fan is not running; and on condition of determining that the fan is not running, electrostatically spraying the solution onto the one or more surfaces using one or more electrostatic nozzles.

Another aspect provides a ventilation system for a cooking appliance, the ventilation system comprising: one or more surfaces; one or more liquid delivery outlets configured to apply a solution to the one or more surfaces, the solution configured to disintegrate deposits within the ventilation system; a liquid delivery system comprising one or more conduits configured to distribute the solution to the one or more liquid delivery outlets of the ventilation system; and a controller configured to dispense the solution by providing the solution into the liquid delivery system on a programmatic basis.

The ventilation system may additionally or alternatively include, wherein the one or more surfaces comprise one or more of a grease baffle, a plenum space, or a duct. The ventilation system may additionally or alternatively include, wherein the one or more conduits comprise one or more of a pipe or a conduit integral to a surface of the ventilation system.

The ventilation system may additionally or alternatively include a pump configured to pressurize the solution, and a valve operated by the controller configured to release the pressurized solution into the liquid delivery system via pulse width modulation control of the valve. The ventilation system may additionally or alternatively include one or more check valves configured to open and provide the solution to the one or more outlets when a pressure of the solution is greater than or equal to a threshold pressure.

The ventilation system may additionally or alternatively include, wherein the controller is configured to provide the solution into the liquid delivery system on the programmatic basis by providing the solution on a predetermined schedule. The ventilation system may additionally or alternatively include a fan, and wherein the controller is configured to provide the solution into the liquid delivery system on the programmatic basis by: determining if the fan is running; on condition of determining that the fan is running, dispensing the solution for application using one or more non-electrostatic nozzles; and on condition of determining that the fan is not running, dispensing the solution for application using one or more electrostatic nozzles.

Another aspect provides a ventilation system for a cooking appliance, the ventilation system comprising: a fan; one or more surfaces; one or more liquid delivery outlets configured to apply a solution to the one or more surfaces, the solution configured to disintegrate deposits within the ventilation system; a liquid delivery system for dispensing the solution, the liquid delivery system comprising one or more conduits configured to distribute the solution to the one or more liquid delivery outlets of the ventilation system; and a controller configured to determine that the fan is running, and on condition of determining that the fan is running, dispense the solution.

The ventilation system may additionally or alternatively include, wherein the controller is configured to provide the solution into the liquid delivery system on a programmatic basis by providing the solution on a predetermined schedule. The ventilation system may additionally or alternatively include one or more electrostatic nozzles, and wherein the controller is configured to provide the solution into the liquid delivery system on a programmatic basis by: determining that the fan is not running; and on condition of determining that the fan is not running, dispensing the solution for application using the one or more electrostatic nozzles.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described methods may be changed.

The subject matter of the present disclosure includes all novel and non-obvious combinations and sub-combinations of the various methods, systems and configurations, and other features, functions, acts, and/or properties disclosed herein, as well as any and all equivalents thereof.

1. A method for cleaning a ventilation system for a cooking appliance, the method comprising:
controlling, via an electronic controller, an introduction of a solution configured to disintegrate deposits within the ventilation system into a liquid delivery system of the ventilation system;
distributing the solution via one or more conduits of the liquid delivery system to one or more liquid delivery outlets of the ventilation system; and
using the one or more liquid delivery outlets of the ventilation system, applying the solution to one or more surfaces within the ventilation system.

2. The method of claim 1, wherein applying the solution to one or more surfaces within the ventilation system comprises applying the solution to one or more of a grease baffle, a plenum, or a duct.

3. The method of claim 1, further comprising distributing the solution along at least a portion of a duct that extends to a fan of the ventilation system.

4. The method of claim 1, wherein distributing the solution via the one or more conduits of the liquid delivery system comprises distributing the solution via one or more of a pipe or a conduit integral to a surface of the ventilation system.

5. The method of claim 1, wherein controlling the introduction of the solution comprises pressurizing the solution and releasing an amount of the pressurized solution into the liquid delivery system.

6. The method of claim 5, wherein releasing the amount of the pressurized solution into the liquid delivery system comprises releasing the amount via a valve operated by the electronic controller via pulse width modulation control of the valve.

7. The method of claim 5, wherein applying the solution to the one or more surfaces comprises providing the solution via one or more check valves configured to open when a pressure of the solution within the liquid delivery system is greater than or equal to a threshold pressure.

8. The method of claim 1, wherein controlling the introduction of the solution comprises providing the solution on a predetermined schedule.

9. The method of claim 1, wherein the ventilation system comprises a fan, and wherein the method further comprises:
determining that the fan is running; and
on condition of determining that the fan is running, applying the solution to the one or more surfaces using one or more non-electrostatic nozzles.

10. The method of claim 1, wherein the ventilation system comprises a fan, the method further comprising:
determining that the fan is not running; and
on condition of determining that the fan is not running, electrostatically spraying the solution onto the one or more surfaces using one or more electrostatic nozzles.

11. A ventilation system for a cooking appliance, the ventilation system comprising:
one or more surfaces;
one or more liquid delivery outlets configured to apply a solution to the one or more surfaces, the solution configured to disintegrate deposits within the ventilation system;
a liquid delivery system comprising one or more conduits configured to distribute the solution to the one or more liquid delivery outlets of the ventilation system; and
a controller configured to dispense the solution by providing the solution into the liquid delivery system on a programmatic basis.

12. The ventilation system of claim 11, wherein the one or more surfaces comprise one or more of a grease baffle, a plenum space, or a duct.

13. The ventilation system of claim 11, wherein the one or more conduits comprise one or more of a pipe or a conduit integral to a surface of the ventilation system.

14. The ventilation system of claim 11, further comprising a pump configured to pressurize the solution, and a valve operated by the controller configured to release the pressurized solution into the liquid delivery system via pulse width modulation control of the valve.

15. The ventilation system of claim 14, further comprising one or more check valves configured to open and provide the solution to the one or more outlets when a pressure of the solution is greater than or equal to a threshold pressure.

16. The ventilation system of claim 11, wherein the controller is configured to provide the solution into the liquid delivery system on the programmatic basis by providing the solution on a predetermined schedule.

17. The ventilation system of claim 11, further comprising a fan, and wherein the controller is configured to provide the solution into the liquid delivery system on the programmatic basis by:
determining if the fan is running;
on condition of determining that the fan is running, dispensing the solution for application using one or more non-electrostatic nozzles; and
on condition of determining that the fan is not running, dispensing the solution for application using one or more electrostatic nozzles.

18. A ventilation system for a cooking appliance, the ventilation system comprising:
a fan;
one or more surfaces;
one or more liquid delivery outlets configured to apply a solution to the one or more surfaces, the solution configured to disintegrate deposits within the ventilation system;
a liquid delivery system for dispensing the solution, the liquid delivery system comprising one or more conduits configured to distribute the solution to the one or more liquid delivery outlets of the ventilation system; and
a controller configured to
determine that the fan is running, and
on condition of determining that the fan is running, dispense the solution.

19. The ventilation system of claim 18, wherein the controller is configured to provide the solution into the liquid delivery system on a programmatic basis by providing the solution on a predetermined schedule.

20. The ventilation system of claim 18, further comprising one or more electrostatic nozzles, and wherein the controller is configured to provide the solution into the liquid delivery system on a programmatic basis by:
determining that the fan is not running; and
on condition of determining that the fan is not running, dispensing the solution for application using the one or more electrostatic nozzles.
